(19) United States
(12) Patent Application Publication
(10) Pub. No.: US 2023/0134805 A1
(43) Pub. Date: May 4, 2023

(54) TERMINAL AND CONNECTOR

(71) Applicant: I-PEX Inc., Kyoto-shi (JP)

(72) Inventor: Koyuru KOISO, Shizuoka-shi (JP)

(73) Assignee: I-PEX Inc., Kyoto-shi (JP)

(21) Appl. No.: 17/975,435

(22) Filed: Oct. 27, 2022

(30) Foreign Application Priority Data
Nov. 2, 2021 (JP) 2021-179174

(51) Int. Cl. H01R 9/05; H01R 24/40; H01B 11/18

(52) U.S. Cl. CPC H01R 9/05; H01R 24/40; H01B 11/1813; H01R 2103/00

(57) ABSTRACT

A terminal includes an outer conductor and a sleeve. The outer conductor includes a first swaging segment. The sleeve has one end adjacent to the +Y side disposed in the outer conductor and the other end adjacent to the -Y side disposed inside a coaxial-cable outer conductor of a coaxial cable. The swaging segment is swaged onto the other end and the coaxial-cable outer conductor. The sleeve may include a first segment disposed inside the coaxial-cable outer conductor and a second segment disposed in the outer conductor.

### CROSS-REFERENCE TO RELATED APPLICATION

This application claims the benefit of Japanese Patent Application No. 2021-179174, filed on Nov. 2, 2021, the entire disclosure of which is incorporated by reference herein.

### FIELD

This application relates to a terminal and a connector.

### BACKGROUND

Unexamined Japanese Patent Application Publication No. 2006-004820 discloses a shield terminal for a coaxial cable including an outer conductor, a braided-layer swaging segment to be swaged on a braided layer of a coaxial cable, a sleeve to be inserted inside the braided layer of the coaxial cable and hold the braided layer against the braided-layer swaging segment, and a sheath swaging segment to be swaged on a sheath of the coaxial cable. In the shield terminal for a coaxial cable disclosed in Unexamined Japanese Patent Application Publication No. 2006-004820, the individual segments are formed integrally with each other using the identical member.

In the shield terminal for a coaxial cable disclosed in Unexamined Japanese Patent Application Publication No. 2006-004820, the integration of the individual segments is achieved by joints connecting the segments to each other. Unfortunately, this configuration may generate a gap between the segments after assembly of the shield terminal for a coaxial cable to the coaxial cable. This gap causes resonance of signals and other troubles, leading to deterioration of high-frequency characteristics in the shield terminal disclosed in Unexamined Japanese Patent Application Publication No. 2006-004820.

An objective of the present disclosure, which has been accomplished under the above situations, is to provide a terminal and a connector that can inhibit deterioration of high-frequency characteristics.

### SUMMARY

In order to achieve the above objective, a terminal according to a first aspect of the present disclosure includes:

an outer conductor including a swaging segment; and

a sleeve having one end and another end, the one end being disposed in the outer conductor, the other end being disposed inside a coaxial-cable outer conductor of a coaxial-cable, the swaging segment being swaged onto the other end and the coaxial-cable outer conductor.

The sleeve may include a first segment disposed inside the coaxial-cable outer conductor and a second segment disposed in the outer conductor.

The first segment and the second segment may each have a hollow cylindrical shape, and

the first segment may have an outer diameter smaller than an outer diameter of the second segment.

The outer conductor may have an inner surface to face an outer peripheral surface of the second segment when the second segment is disposed in the outer conductor, and

the outer peripheral surface of the second segment may be at least partially in contact with the inner surface of the outer conductor while the second segment of the sleeve is disposed in the outer conductor.

The outer conductor and the sleeve may each include a bent plate member, and

the sleeve may have a thickness different from a thickness of the outer conductor.

The sleeve may be a component separate from the outer conductor.

The coaxial-cable outer conductor may include braided metal wires.

A connector according to a second aspect of the present disclosure includes:

the terminal according to the first aspect of the present disclosure; and

a housing to accommodate the terminal.

In the terminal and the connector according to aspects of the present disclosure, one end of the sleeve is inserted in the outer conductor, the other end of the sleeve is inserted inside the coaxial-cable outer conductor, and the swaging segment is swaged onto the other end and the coaxial-cable outer conductor. This configuration can achieve a terminal and a connector that can inhibit deterioration of high-frequency characteristics.

### BRIEF DESCRIPTION OF THE DRAWINGS

A more complete understanding of this application can be obtained when the following detailed description is considered in conjunction with the following drawings, in which:

FIG. 1 is a perspective view of a connector and a connector unit according to an embodiment of the present disclosure;

FIG. 2 is an exploded perspective view of the connector unit;

FIG. 3 is a perspective view of a mating connector;

FIG. 4 is an exploded top view of the connector unit;

FIG. 5 is a sectional view taken along the line V-V of FIG. 4;A

FIG. 6 is a sectional view configured by simplifying some parts of FIG. 5;

FIG. 7 is a perspective view of a terminal and the mating terminal;

FIG. 8 is a first exploded perspective view of a housing and the terminal;

FIG. 9A is a first perspective view for describing a structure of the terminal;

FIG. 9B is a second perspective view for describing the structure of the terminal;

FIG. 10 is a second exploded perspective view of the housing and the terminal;

FIG. 11A is a first perspective view for describing a procedure of connecting the terminal and a coaxial cable;

FIG. 11B is a second perspective view for describing the procedure of connecting the terminal and the coaxial cable;

FIG. 11C is a third perspective view for describing the procedure of connecting the terminal and the coaxial cable;

FIG. 12A is a fourth perspective view for describing the procedure of connecting the terminal and the coaxial cable;

FIG. 12B is a fifth perspective view for describing the procedure of connecting the terminal and the coaxial cable;

FIG. 12C is a sixth perspective view for describing the procedure of connecting the terminal and the coaxial cable; and

FIG. 13 is a seventh perspective view for describing the procedure of connecting the terminal and the coaxial cable.

### DETAILED DESCRIPTION

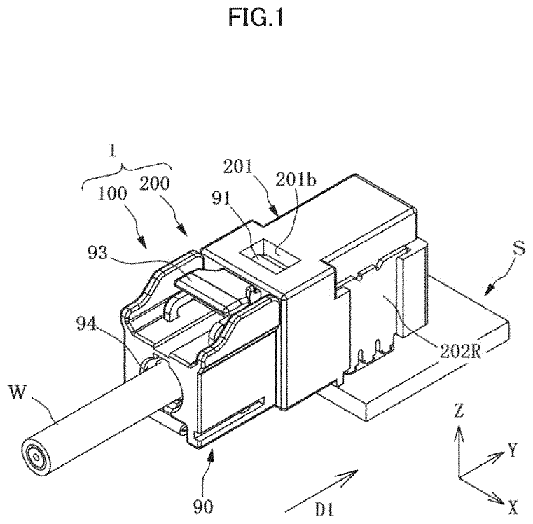

A terminal 10 according to an embodiment of the present disclosure and a connector 100 including the terminal 10 are described below with reference to the accompanying drawings. In order to facilitate an understanding, XYZ coordinates orthogonal to each other are defined and referred to in the description as appropriate. As illustrated in FIG. 1, +Y direction of the XYZ coordinates is identical to a fitting direction D1 in which the connector 100 shifts to be fitted into a mating connector 200, which is a partner of the connector 100. The X-axis directions are identical to the width directions of the connector 100. The Z-axis directions are identical to the height directions of the connector 100 and orthogonal to both of the X-axis and Y-axis directions.

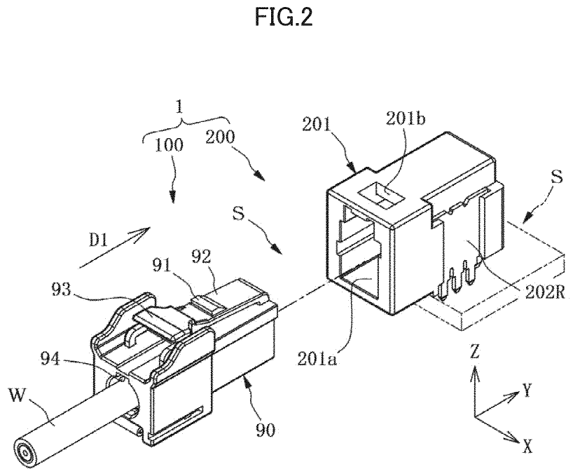

A connector unit 1 is an in-vehicle connector unit serving as an automobile component, for example. As illustrated in FIGS. 1 and 2, the connector unit 1 includes the connector 100 and the mating connector 200, into which the connector 100 is fitted. The connector unit 1 is used to connect a coaxial cable W extending from an electronic component installed in an automobile to an installed device S, which is one of the components installed in the automobile. The installed device S in this embodiment is a circuit board. The installed device S is not necessarily a circuit board and may also be a component other than the circuit board.

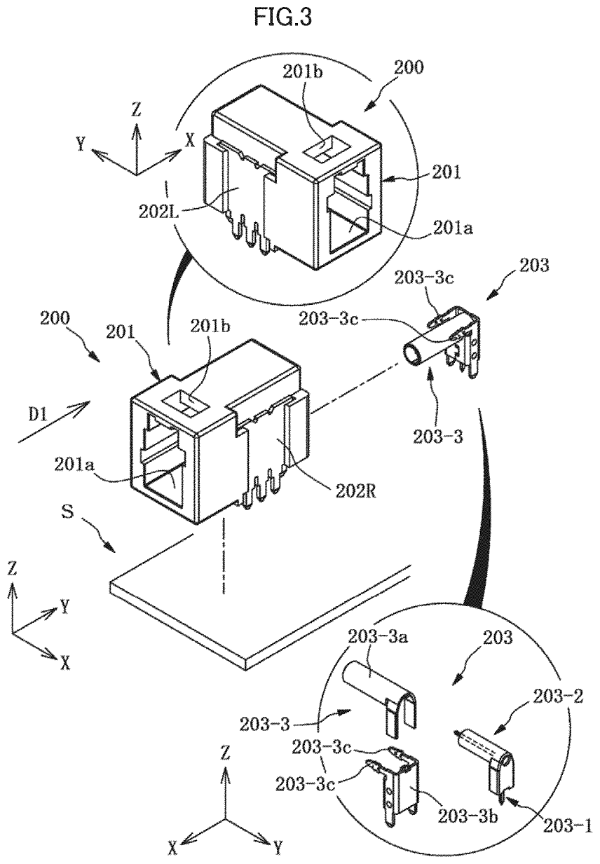

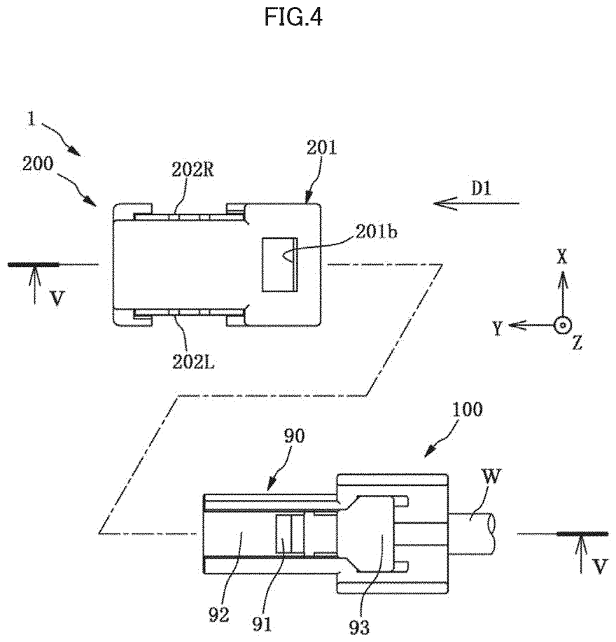

The mating connector 200 is provided to the installed device S by a through hole reflow technique, and receives the connector 100 therein. As illustrated in FIGS. 3 and 4, the mating connector 200 includes a mating housing 201, retainers 202R and 202L, and a mating terminal 203.

The mating housing 201 has a substantially box shape defining a fitting hole 201a that is open in the -Y direction and receives the connector 100 therein. The mating housing 201 is made of an insulating material, such as resin. The mating housing 201 is provided with a part of the mating terminal 203 pressed through the rear end face (end face adjacent to the +Y side) of the mating housing 201 and fixed inside the mating housing 201. The mating housing 201 also has an engaged hole 20 lb.

The engaged hole 201b extends in the Z-axis directions from the outside of the mating housing 201 to the inside of the fitting hole 201a . Although the engaged hole 201b in this embodiment is a through hole extending in the Z-axis directions, this configuration is a mere example. The engaged hole 201b may also be a hole having a bottom.

The retainers 202R and 202L are fixed at the mating housing 201 and also fixed at the installed device S. The retainers 202R and 202L are made of a metal having a relatively high rigidity, for example. The retainers 202R and 202L can achieve firm fixation of the mating housing 201 to the installed device S.

The mating terminal 203 includes an inner conductor 203-1, a dielectric element 203-2, and an outer conductor 203-3, which are combined with each other.

The inner conductor 203-1 is made of an electrically conductive material, for example. Examples of the electrically conductive material include copper and copper alloys. The inner conductor 203-1 has a shape of a rod member bent into an L-shape.

The dielectric element 203-2 is disposed over the inner conductor 203-1. The dielectric element 203-2 in this embodiment is formed integrally with the inner conductor 203-1 by insert molding. The dielectric element 203-2 is made of an insulating material, for example. The dielectric element 203-2 has a substantially L-shape.

The outer conductor 203-3 is disposed over the dielectric element 203-2. The outer conductor 203-3 is formed by bending a plate member made of an electrically conductive material. Examples of the electrically conductive material of the plate member include copper and copper alloys. The outer conductor 203-3 includes two segments, that is, a main segment 203-3a and a lid segment 203-3b, which are combined with each other.

The main segment 203-3a is designed to accommodate the dielectric element 203-2, as well as the inner conductor 203-1. The main segment 203-3a has a substantially hollow cylindrical shape of which the axis extends in the Y-axis directions.

The lid segment 203-3b in this embodiment is a component separate from the main segment 203-3a, and is designed to cover a part of the dielectric element 203-2 accommodated in the main segment 203-3a . The lid segment 203-3b has a pair of engaging sections 203-3c .

The engaging sections 203-3c engage with the inside of the mating housing 201 and thereby fix the mating terminal 203 to the mating housing 201.

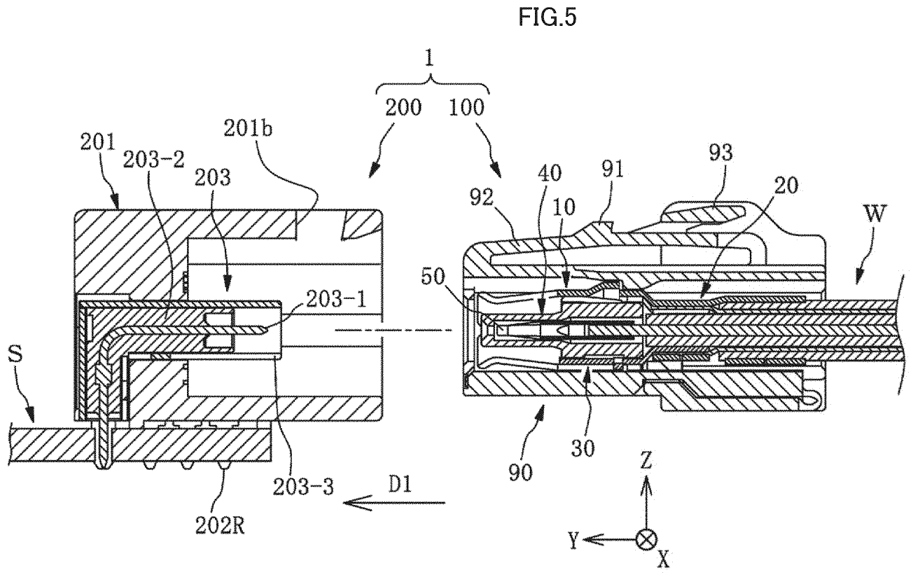

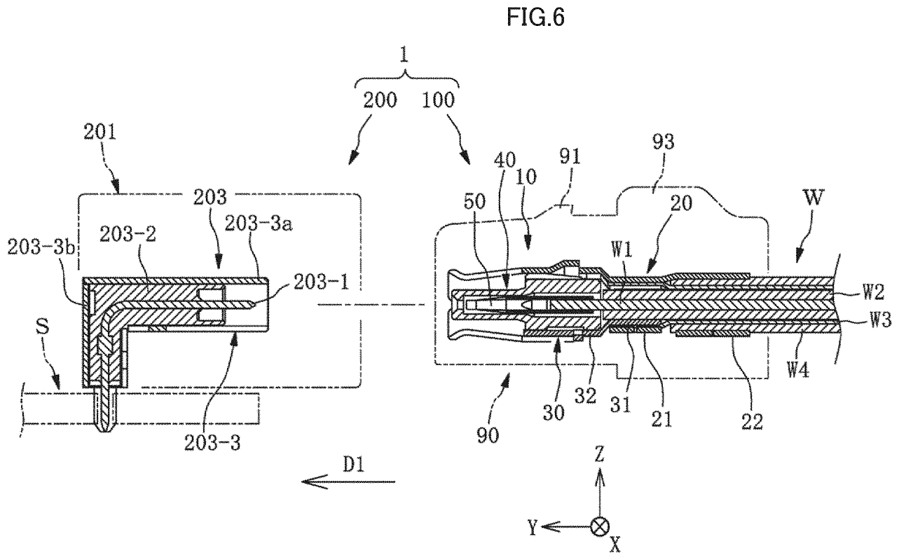

As illustrated in FIGS. 5 and 6, the connector 100 includes the terminal 10 and a housing 90.

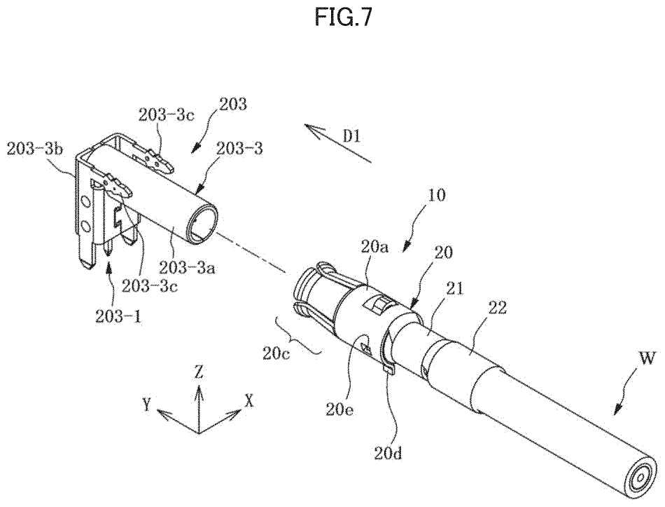

The terminal 10 is connected to the coaxial cable W by swaging, as illustrated in FIG. 7.

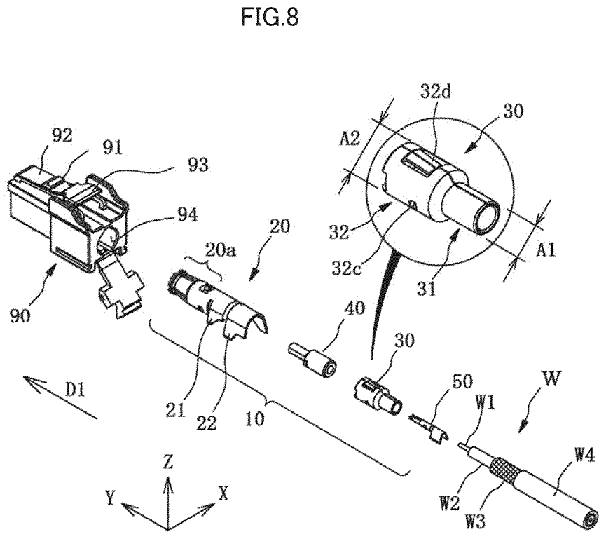

As illustrated in FIG. 8, the coaxial cable W in this embodiment includes a center conductor W1, an insulating element W2, a coaxial-cable outer conductor W3, and a cover W4.

The center conductor W1 is made of an electrically conductive material. The center conductor W1 propagates high-frequency signals.

The insulating element W2 is made of an insulating material. The insulating element W2 is disposed between the center conductor W1 and the coaxial-cable outer conductor W3 so as to cover the center conductor W1.

The coaxial-cable outer conductor W3 is made of an electrically conductive material. The coaxial-cable outer conductor W3 is a braided layer formed by braiding metal wires, for example.

The cover W4 is made of an insulating material. The cover W4 is disposed over the center conductor W1, the insulating element W2, and the coaxial-cable outer conductor W3, and thereby protect these components.

As illustrated in FIG. 8, the terminal 10 includes an outer conductor 20, a sleeve 30, a dielectric element 40, and a central terminal 50.

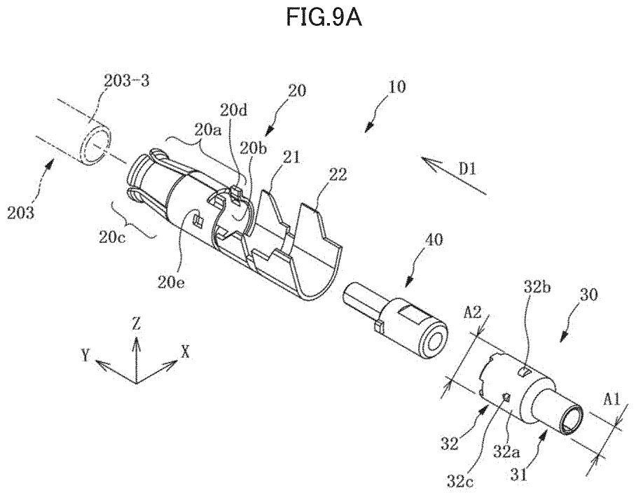

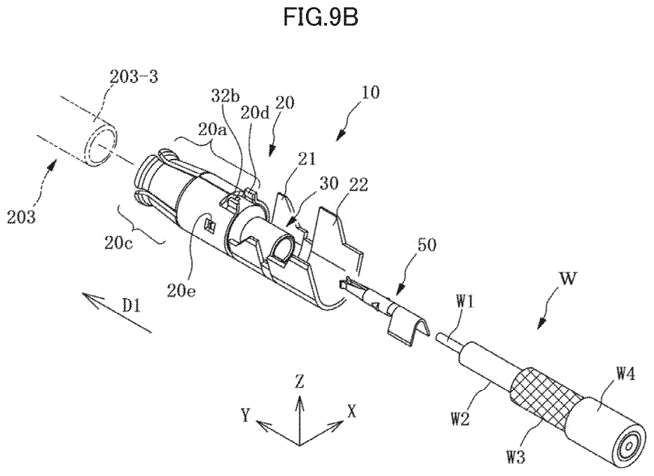

The outer conductor 20 is electrically connected to the coaxial-cable outer conductor W3 of the coaxial cable W. The outer conductor 20 serves as a ground terminal for efficient propagation of high-frequency signals in the central terminal 50. The outer conductor 20 prevents high-frequency signals from leaking to the outside of the coaxial cable W and the terminal 10 and blocks radio waves from the outside. The outer conductor 20 is formed by bending a plate member made of an electrically conductive material, for example. Examples of the electrically conductive material of the plate member include copper and copper alloys. The outer conductor 20 includes a main segment 20a, as illustrated in FIGS. 8 and 9. The outer conductor 20 also includes a first swaging segment 21 and a second swaging segment 22.

The main segment 20a has a hollow cylindrical shape of which the axis extends in the Y-axis directions. The main segment 20a has a hollow cylindrical end 20c adjacent to the +Y side having warping segments that can warp in radial directions (directions orthogonal to the Y-axis directions). When the hollow cylindrical end 20c receives the outer conductor 203-3 of the mating terminal 203 therein, this warping mechanism brings the hollow cylindrical end 20c into contact with the outer peripheral surface of the outer conductor 203-3. This contact causes the outer conductor 20 of the terminal 10 to be electrically connected to the outer conductor 203-3 of the mating terminal 203. The main segment 20a also has a protrusion 20d for defining the insertion direction, which is designed to define the direction of insertion of the outer conductor 20 to the housing 90, and engaged sections 20e, which are through holes extending in radial directions.

The first swaging segment 21 (swaging segment) is swaged onto the coaxial-cable outer conductor W3. The swaging of the first swaging segment 21 onto the coaxial-cable outer conductor W3 causes the outer conductor 20 to be electrically connected to the coaxial-cable outer conductor W3. The first swaging segment 21 extends from the end of the main segment 20a adjacent to the -Y side. The end of the first swaging segment 21 adjacent to the −Y side adjoins the second swaging segment 22 extending therefrom.

The second swaging segment 22 is swaged onto the cover W4. The swaging of the second swaging segment 22 onto the cover W4 causes the terminal 10 to be rigidly fixed to the coaxial cable W.

The sleeve 30 has a shape having two hollow cylindrical segments having different outer diameters. The sleeve 30 is a member separate from the outer conductor 20. The sleeve 30 is formed by bending a plate member made of an electrically conductive material, for example. Examples of the electrically conductive material of the plate member include copper and copper alloys. The sleeve 30 in this embodiment has a thickness different from the thickness of the outer conductor 20. The end of the sleeve 30 adjacent to the +Y side is inserted in the main segment 20a of the outer conductor 20, and the end of the sleeve 30 adjacent to the -Y side is inserted inside the coaxial-cable outer conductor W3. After insertion of the end of the sleeve 30 adjacent to the −Y side inside the coaxial-cable outer conductor W3, the first swaging segment 21 is swaged onto this end together with the coaxial-cable outer conductor W3. The sleeve 30 includes a first segment 31 corresponding to the end adjacent to the −Y side and a second segment 32 corresponding to the end adjacent to the +Y side. The second segment 32 corresponding to the end of the sleeve 30 adjacent to the +Y side is preliminarily inserted in the outer conductor 20 at the time of assembly of the terminal 10. This feature can improve the efficiency of assembly of the terminal 10.

The first segment 31 is configured to be inserted inside the coaxial-cable outer conductor W3, in detail, inserted between the insulating element W2 and the coaxial-cable outer conductor W3. The first segment 31 has a hollow cylindrical shape.

The second segment 32 is configured to be inserted in the main segment 20a of the outer conductor 20. The second segment 32 has a hollow cylindrical shape. The second segment 32 has an outer diameter A2 larger than an outer diameter A1 of the first segment 31 (A2>A1). While the second segment 32 is disposed in the outer conductor 20, an outer peripheral surface 32a of the second segment 32 is at least partially in contact with an inner surface 20b of the outer conductor 20. The outer peripheral surface 32a of the second segment 32 has a stopper 32b, engaging sections 32c, and an engaging section 32d.

The stopper 32b protrudes from the outer peripheral surface 32a of the second segment 32. The stopper 32b comes into contact with a part of the outer conductor 20 when the sleeve 30 is inserted in the outer conductor 20, and thereby determining the position of the sleeve 30 in the Y-axis directions relative to the outer conductor 20.

The engaging sections 32c protrude from the outer peripheral surface 32a of the second segment 32. The engaging sections 32c engage with the respective engaged sections 20e of the main segment 20a of the outer conductor 20.

The engaging section 32d serves to fix the dielectric element 40 to the sleeve 30. The engaging section 32d has a free end and extends in the Y-axis directions. The engaging section 32d is inclined toward the central axis of the sleeve 30 such that the distal end of the engaging section 32d can catch the dielectric element 40.

The dielectric element 40 serves to match the characteristic impedances of transmission lines and achieve efficient propagation of high-frequency signals in the central terminal 50. The dielectric element 40 has a shape having two hollow cylindrical segments having different outer diameters. The dielectric element 40 receives the central terminal 50 fitted therein.

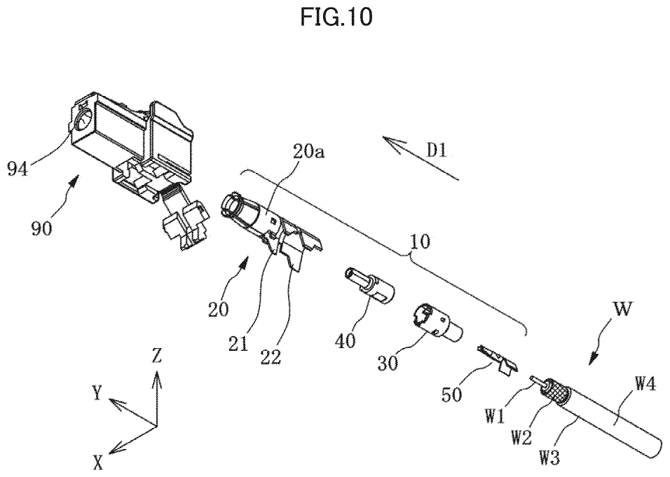

As illustrated in FIGS. 8 and 10, the central terminal 50 is swaged and fixed onto the center conductor W1 of the coaxial cable W and thereby electrically connected to the center conductor W1, so that the central terminal 50 and the center conductor W1 propagate high-frequency signals. The central terminal 50 and the dielectric element 40 are disposed inside the sleeve 30, as illustrated in FIG. 6. The central terminal 50 has an end adjacent to the +Y side, which includes a pair of elastic contact segments to hold the inner conductor 203-1 therebetween and thus be electrically connected to the inner conductor 203-1.

As illustrated in FIG. 2, the housing 90 is shaped so as to be fitted in the fitting hole 201a of the mating housing 201 of the mating connector 200. The housing 90 is made of an insulating material, such as resin. The housing 90 includes an engaging section 91, a support arm 92, an operative tab 93, and a through hole 94.

The engaging section 91 engages with the engaged hole 201b of the mating housing 201 of the mating connector 200 and thereby fixes the housing 90 to the mating connector 200. The engaging section 91 protrudes from the support arm 92 in the +Z direction.

The support arm 92 extends from the end of the housing 90 adjacent to the +Y end in the rearward direction (−Y direction). The support arm 92 is configured to warp in accordance with the progress of fitting of the connector 100 into the mating connector 200.

The operative tab 93 is mounted on the support arm 92. The operative tab 93 is manipulated by an operator who is going to detach the connector 100 from the mating connector 200. The operative tab 93 is allowed to shift in the Z-axis directions by warping of the support arm 92. The operative tab 93 shifted in the -Z direction disengages the engaging section 91 from the engaged hole 20 lb.

As illustrated in FIGS. 8 and 10, the through hole 94 is an opening into which the terminal 10 and the coaxial cable W are inserted. The through hole 94 extends in the Y-axis directions.

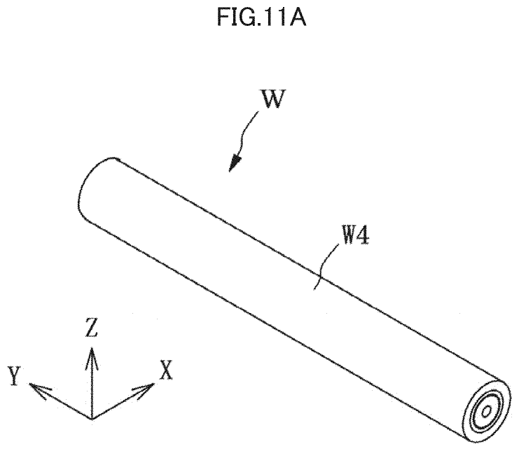

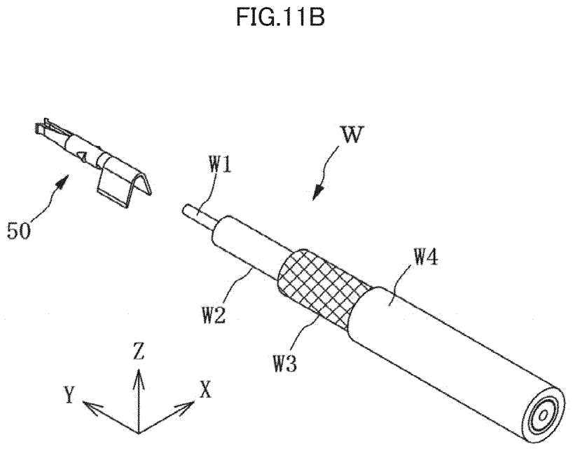

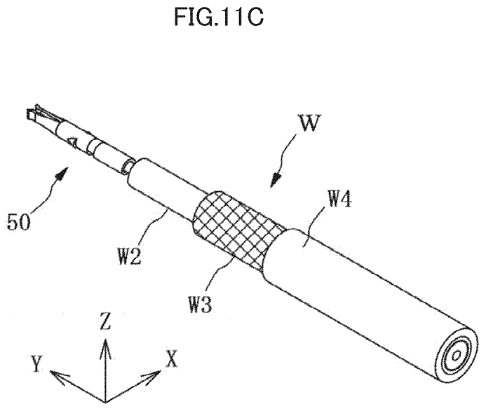

A procedure of connecting the terminal 10 having the above-described configuration and the coaxial cable W (that is, a swaging procedure) is described with reference to FIGS. 11 to 13 . This procedure of connecting the terminal 10 and the coaxial cable W is carried out by not only an operator himself or herself but also an automatic machine as appropriate, which serves to combine the sleeve 30 and the dielectric element 40 with the outer conductor 20.

The operator first prepares the coaxial cable W, as illustrated in FIGS. 11A and 11B. The operator then peels or removes the cover W4, the coaxial-cable outer conductor W3, and the insulating element W2 at the end of the coaxial cable W adjacent to the +Y side, so that the coaxial-cable outer conductor W3, the insulating element W2, and the center conductor W1 are exposed to the outside. The operator then swages and fixes the central terminal 50 onto the center conductor W1, as illustrated in FIG. 11C. The central terminal 50 is thus electrically connected to the center conductor W1 of the coaxial cable W.

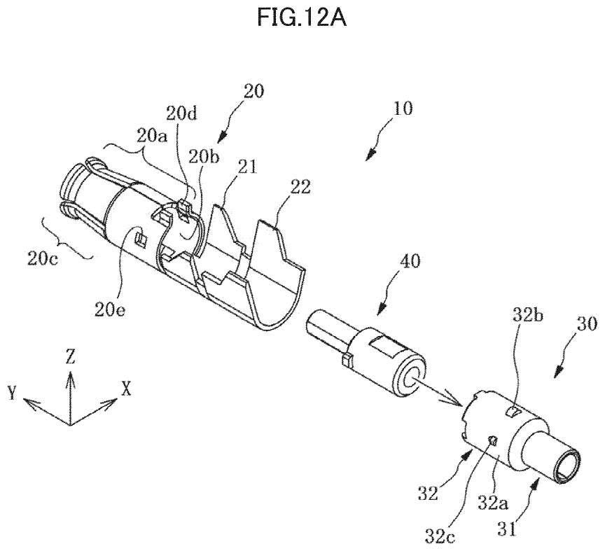

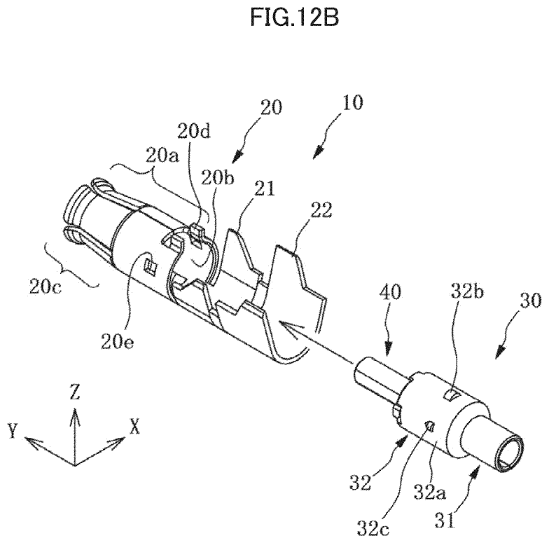

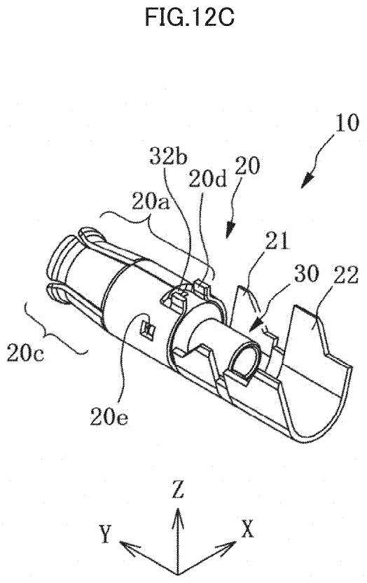

The outer conductor 20, the sleeve 30, and the dielectric element 40 prepared as illustrated in FIG. 12A are then subject to the following steps. The dielectric element 40 is inserted and fitted into the sleeve 30, as illustrated in FIG. 12B, by the automatic machine, for example. Then, the one end of the sleeve 30, in which the dielectric element 40 is fitted, is inserted into the outer conductor 20, as illustrated in FIG. 12C, by the automatic machine, for example. The operator can thus obtain the outer conductor 20 in which the dielectric element 40 is installed and the one end of the sleeve 30 is preliminarily inserted (that is, the member illustrated in FIG. 12C).

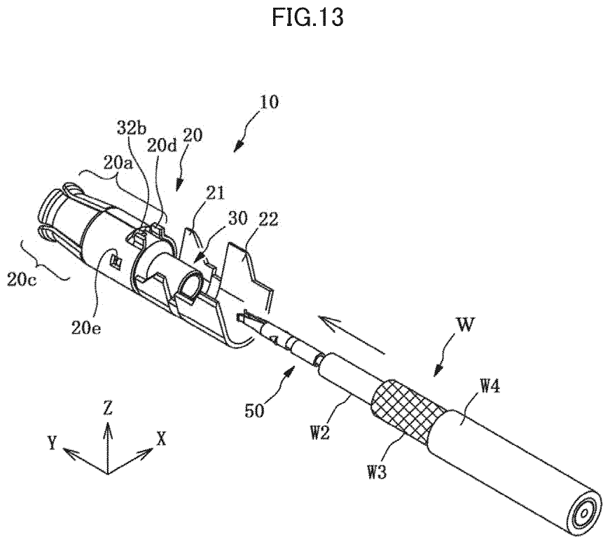

The operator then inserts the coaxial cable W, onto which the central terminal 50 is swaged, into the outer conductor 20 in which the one end of the sleeve 30 is preliminarily inserted, as illustrated in FIG. 13. The operator then swages the first swaging segment 21 and the second swaging segment 22, thereby completing the connection between terminal 10 and the coaxial cable

W. Although the above-described procedure for connecting the terminal 10 and the coaxial cable W involves steps carried out by the operator himself or herself and steps executed by the automatic machine, this configuration is a mere example. For example, although the step of inserting the sleeve 30 into the outer conductor 20 illustrated in FIG. 12B is executed by the automatic machine, this configuration is a mere example, and this step may also be carried out by the operator himself or herself. Alternatively, all the steps of the above-described procedure for connecting the terminal 10 and the coaxial cable W may be carried out by the operator, or may be executed by the automatic machine. The steps of the procedure for connecting the terminal 10 and the coaxial cable W can be shared by the operator himself or herself and the automatic machine as appropriate.

As described above, in the terminal 10 according to this embodiment, the end of the sleeve 30 adjacent to the +Y side is preliminarily inserted in the outer conductor 20, as illustrated in FIG. 9. The end of the sleeve 30 adjacent to the −Y side is inserted inside the coaxial-cable outer conductor W3, and the first swaging segment 21 is swaged onto this end together with the coaxial-cable outer conductor W3. This configuration rarely generates a gap between the sleeve 30 of the terminal 10 and the coaxial-cable outer conductor W3 of the coaxial cable W. The configuration can therefore prevent signals propagating in the terminal 10 and the coaxial cable W from resonating due to the gap between the components of the terminal 10 and the coaxial cable W. The configuration can accordingly achieve the terminal 10 capable of inhibiting deterioration of high-frequency characteristics.

In this embodiment, the end of the sleeve 30 adjacent to the +Y side is preliminarily inserted in the outer conductor 20. The coaxial cable W, onto which the central terminal 50 is swaged, is then inserted in the outer conductor 20, in which the end of the sleeve 30 adjacent to the +Y side is preliminarily inserted. This configuration can improve the efficiency of the procedure for connecting the terminal 10 and the coaxial cable W.

The above-described embodiment is not to be construed as limiting the scope of the present disclosure.

For example, although the sleeve 30 in the above-described embodiment includes the first segment 31 to be inserted inside the coaxial-cable outer conductor W3 and the second segment 32 to be inserted in the main segment 20a of the outer conductor 20 as illustrated in FIG. 9, the sleeve 30 may also have another shape or structure. The sleeve 30 may include not only the first segment 31 and the second segment 32 but also another segment other than the first segment 31 and the second segment 32. For example, the sleeve 30 may include a third segment having a hollow cylindrical shape between the first segment 31 and the second segment 32. The third segment in this example has an outer diameter different from the outer diameter Al of the first segment 31 and the outer diameter A2 of the second segment 32.

Although the first segment 31 and the second segment 32 in the above-described embodiment each have a hollow cylindrical shape, the first segment 31 and the second segment 32 may also have another shape or structure. For example, one or both of the first segment 31 and the second segment 32 may have a hollow truncated-cone shape inclined in the Y-axis directions. Alternatively, the first segment 31 and the second segment 32 may have a shape other than the hollow cylindrical shape and the hollow truncated-cone shape.

Although the outer diameter A1 of the first segment 31 is smaller than the outer diameter A2 of the second segment 32 in the above-described embodiment, this configuration is a mere example. The outer diameter A1 of the first segment 31 may also be identical to the outer diameter A2 of the second segment 32 (A1=A2), or larger than the outer diameter A2 of the second segment 32 (A1>A2).

Although the outer peripheral surface 32a of the second segment 32 of the sleeve 30 is partially in contact with the inner surface 20b of the outer conductor 20 while the second segment 32 is disposed in the outer conductor 20 in the above-described embodiment, this configuration is a mere example. The outer peripheral surface 32a of the second segment 32 of the sleeve 30 may also be entirely in contact with the inner surface 20b of the outer conductor 20 while the second segment 32 is disposed in the outer conductor 20.

Although the sleeve 30 has a thickness different from the thickness of the outer conductor 20 in the above-described embodiment, this configuration is a mere example. The sleeve 30 may also have a thickness identical to the thickness of the outer conductor 20.

Although the coaxial-cable outer conductor W3 is formed by braiding metal wires in the above-described embodiment, this configuration is a mere example. The coaxial-cable outer conductor W3 may also have another shape provided that the coaxial-cable outer conductor W3 is electrically conductive.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Connector unit

10 Terminal

20 Outer conductor

20a Main segment

20b Inner surface

20c Hollow cylindrical end

20d Protrusion for defining the insertion direction

20e Engaged section

21 First swaging segment (swaging segment)

22 Second swaging segment

30 Sleeve

31 First segment

32 Second segment

32a Outer peripheral surface

32b Stopper

32c, 32d Engaging section

40 Dielectric element

50 Central terminal

90 Housing

91 Engaging section

92 Support arm

93 Operative tab

94 Through hole

100 Connector

200 Mating connector

201 Mating housing

201a Fitting hole

201b Engaged hole

202R, 202L Retainer

203 Mating terminal

203-1 Inner conductor

203-2 Dielectric element

203-3 Outer conductor

203-3a Main segment

203-3b Lid segment

203-3c Engaging section

W Coaxial cable

W1 Center conductor

W2 Insulating element

W3 Coaxial-cable outer conductor

W4 Cover

S Installed device

D1 Fitting direction

A1, A2 Outer diameter

1. A terminal, comprising:
an outer conductor including a swaging segment; and
a sleeve having one end and another end, the one end being disposed in the outer conductor, the other end being disposed inside a coaxial-cable outer conductor of a coaxial-cable, the swaging segment being swaged onto the other end and the coaxial-cable outer conductor.

2. The terminal according to claim 1, wherein the sleeve includes a first segment disposed inside the coaxial-cable outer conductor and a second segment disposed in the outer conductor.

3. The terminal according to claim 2, wherein the first segment and the second segment each have a hollow cylindrical shape, and
the first segment has an outer diameter smaller than an outer diameter of the second segment.

4. The terminal according to claim 2, wherein the outer conductor has an inner surface to face an outer peripheral surface of the second segment when the second segment is disposed in the outer conductor, and
the outer peripheral surface of the second segment is at least partially in contact with the inner surface of the outer conductor while the second segment of the sleeve is disposed in the outer conductor.

5. The terminal according to claim 1, wherein the outer conductor and the sleeve each includes a bent plate member, and
the sleeve has a thickness different from a thickness of the outer conductor.

6. The terminal according to claim 1, wherein the sleeve is a component separate from the outer conductor.

7. The terminal according to claim 1, wherein the coaxial-cable outer conductor includes braided metal wires.

8. A connector, comprising:
a terminal including:
an outer conductor including a swaging segment and
a sleeve having one end and another end, the one end being disposed in the outer conductor, the other end being disposed inside a coaxial-cable outer conductor of a coaxial-cable, the swaging segment being swaged onto the other end and the coaxial-cable outer conductor; and
a housing to accommodate the terminal.
